(19) United States
(12) Patent Application Publication
(10) Pub. No.: US 2014/0337426 A1
(43) Pub. Date: Nov. 13, 2014

(54) USE OF HANDHELD DEVICES (PHONES/TABLETS) AS SPEAKERS TO MAKE MULTICHANNEL AUDIO CONFIGURATION OVER WI-FI

(71) Applicant: NVIDIA CORPORATION, Santa Clara, CA (US)

(72) Inventors: Prasad Chandrakant KULKARNI, Nanded (IN); Hardik Jagdishbhai PAREKH, Rajkot (IN); Apoorva Govindbhai PANELIYA, Rajkot (IN)

(73) Assignee: NVIDIA CORPORATION, Santa Clara, CA (US)

(21) Appl. No.: 13/892,913

(22) Filed: May 13, 2013

(51) Int. Cl. H04L 29/08

(52) U.S. Cl. CPC H04L 67/10
USPC 709/204

(57) ABSTRACT

An approach is provided for managing multichannel playback of audio data over a wireless network. In one example, a host device determines one or more client devices that are eligible to receive a transmission of the audio data over a wireless network from the host device for playback of the audio data. The host device displays the one or more client devices that are eligible. The host device receives a selection of at least one of the client devices. The host device establishes a connection to each of the selected client devices for the host device to transmit at least one channel of the audio data to each of the selected client devices over the wireless network. The host device displays a map of positions of the connected client devices.

### BACKGROUND OF THE INVENTION

1. Field of the Invention

The present invention relates generally to audio playback and, more specifically, to multi-channel audio playback over a wireless network.

2. Description of the Related Art

A mobile device (e.g., cell phone, smart phone, tablet computer, laptop computer, etc.) typically has a single inbuilt speaker that can play audio in a monophonic mode. Some mobile devices provide stereophonic support with two inbuilt speakers. Oftentimes, a user desires to listen to audio in more than the monophonic mode or the stereophonic mode provided by the inbuilt speaker, or speakers, on the mobile device.

Unfortunately, the user has limited options for listening to audio data from the mobile device via anything other than the inbuilt speaker or speakers. One option for the user is to connect the mobile device to a headset via, for example, a 3.5 mm jack on the mobile device to transmit audio data to speakers in the headset. Another option is for the user to use the 3.5 mm jack to connect the mobile device to an external amplifier and external speakers.

A disadvantage here is that these conventional setups still do not provide multichannel (e.g., 2.1, 3.1, 4.1, 5.1, or 7.1, etc.) support for the audio listening experience. Further, the conventional setups typically involve the inconvenient use of wires to connect the mobile device directly to the headset or to the speakers.

Accordingly, what is needed is functionality on a mobile device that enables multichannel support for transmission of audio data.

### SUMMARY OF THE INVENTION

One implementation of the present approach includes a method for a host device to manage multichannel playback of audio data. In one example, the method includes determining one or more client devices that are eligible to receive a transmission of the audio data over a wireless network from the host device for playback of the audio data; displaying the one or more client devices that are eligible; receiving a selection of at least one of the client devices; and establishing a connection to each of the selected client devices for the host device to transmit at least one channel of the audio data to each of the selected client devices over the wireless network. The method may also include displaying a map of positions of the connected client devices.

Advantageously, the present approach does not require additional hardware to implement the multichannel communication. The host device can send one or more channels to existing inbuilt speakers of the client devices and/or the host device. The audio system is highly scalable according to the needs of the user. For example, with enough client devices participating, the host device can configure the audio system, including the client devices and/or the host device, to play audio data according to a channel configuration of 2.1, 3.1, 4.1, 5.1, or 7.1, and so on. The audio system of the present approach is also highly portable. For example, wherever a host device is located in a capable wireless network with capable client devices, the host device can form and manage a multichannel audio system. The managed audio system can emit a sound that the user perceives as a full-fledge multi-channel audio system.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system in which one or more aspects of the present invention may be implemented.

FIG. 2 is a conceptual diagram of an audio system that includes a management engine on a host device, according to one embodiment of the present invention.

FIG. 3 is a conceptual diagram of a system for determining the eligible client devices for the audio system, according to one embodiment of the present invention.

FIG. 4 is a conceptual diagram of the host device after the host device discovers which client device are eligible for pairing, according to one embodiment of the present invention.

FIG. 5 is a diagram showing the physical locations of the selected client devices of FIG. 4, according to one embodiment of the present invention.

FIG. 6 is a conceptual diagram of the host device displaying a map of the selected client devices of FIGS. 4 and 5, according to one embodiment of the present invention.

FIG. 7 is a diagram showing the physical locations of the selected client devices of FIG. 4, according to one embodiment of the present invention.

FIG. 8 is a conceptual diagram of the host device displaying the map of the selected client devices at updated positions, according to one embodiment of the present invention.

FIG. 9 is a flowchart of method steps for managing multichannel playback of audio data, according to embodiments of the present invention.

### DETAILED DESCRIPTION OF EXEMPLARY EMBODIMENTS

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Among other things, embodiments of the present invention are directed to managing multichannel playback of audio data over a wireless network. Nowadays, most mobile devices (e.g., smart phones, tablets, etc.) are equipped with components for communicating over a wireless network (e.g., Wireless Fidelity (Wi-Fi), etc.). An end-user typically connects a cell phone or tablet to a wireless network that is established at home or at work, for example. The end-user can also set up a Wi-Fi hotspot. In a wireless network several devices can connect to the wireless network at any given time. The present approach manages these connected devices over the wireless network and transmits multichannel (2.1, 3.1, 4.1, 5.1, or 7.1, etc.) audio data to the connected devices, which play the audio data on speakers.

### Hardware Overview

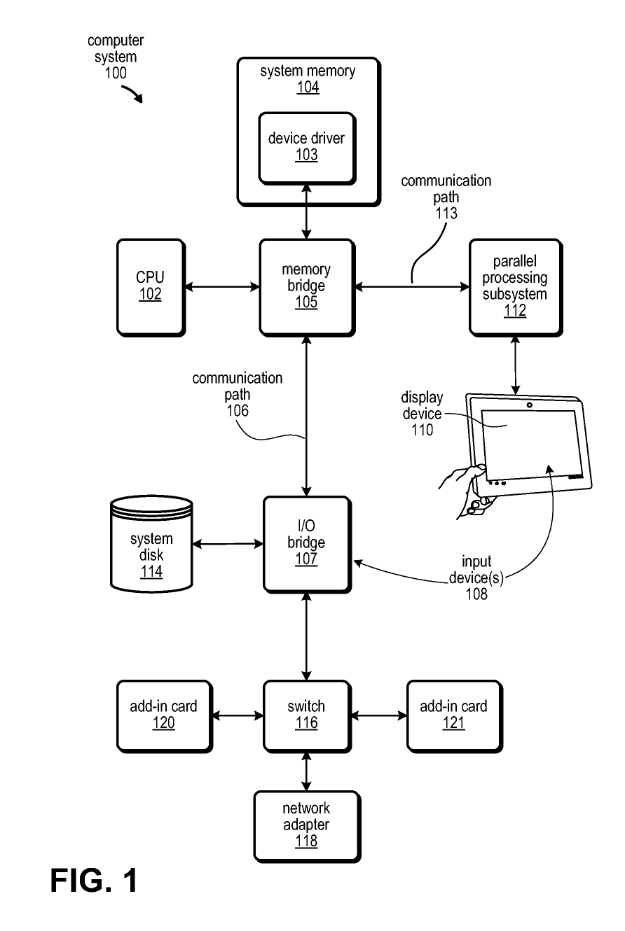

FIG. 1 is a block diagram illustrating a computer system 100 in which one or more aspects of the present invention may be implemented. FIG. 1 in no way limits or is intended to limit the scope of the present invention. Computer system 100 may be a cell phone, smart phone, mobile phone, mobile device, personal digital assistant, tablet computer, laptop computer, personal computer or any other device suitable for practicing one or more embodiments of the present invention. A device is hardware or a combination of hardware and software. A component is typically a part of a device and is hardware or a combination of hardware and software.

Computer system 100 includes a central processing unit (CPU) 102 and a system memory 104 that includes a device driver 103. CPU 102 and system memory 104 communicate via an interconnection path that may include a memory bridge 105. Memory bridge 105, which may be, for example, a Northbridge chip, is connected via a bus or other communication path 106 (e.g., a HyperTransport link, etc.) to an input/output (I/O) bridge 107. I/O bridge 107, which may be, for example, a Southbridge chip, receives user input from one or more user input devices 108 (e.g., touch screen, cursor pad, keyboard, mouse, etc.) and forwards the input to CPU 102 via path 106 and memory bridge 105. A parallel processing subsystem 112 is coupled to memory bridge 105 via a bus or other communication path 113 (e.g., peripheral component interconnect (PCI) express, Accelerated Graphics Port (AGP), and/or HyperTransport link, etc.). In one implementation, parallel processing subsystem 112 is a graphics subsystem that delivers pixels to a display device 110 (e.g., a conventional cathode ray tube (CRT) and/or liquid crystal display (LCD) based monitor, etc.). A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) and/or other port connections, compact disc (CD) drives, digital video disc (DVD) drives, film recording devices, and the like, may also be connected to I/O bridge 107. Communication paths interconnecting the various components in FIG. 1 may be implemented using any suitable protocols, such as PCI, PCI Express (PCIe), AGP, HyperTransport, and/or any other bus or point-to-point communication protocol(s), and connections between different devices that may use different protocols as is known in the art.

In one implementation, the parallel processing subsystem 112 incorporates circuitry optimized for graphics and video processing, including, for example, video output circuitry, and constitutes a graphics processing unit (GPU). In another implementation, the parallel processing subsystem 112 incorporates circuitry optimized for general purpose processing, while preserving the underlying computational architecture, described in greater detail herein. In yet another implementation, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some implementations, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other implementations, I/O bridge 107 and memory bridge 105 might be integrated into a single chip. Large implementations may include two or more CPUs 102 and two or more parallel processing systems 112. The particular components shown herein are optional; for instance, any number of add-in cards or peripheral devices might be supported. In some implementations, switch 116 is eliminated, and network adapter 118 and add-in cards 120, 121 connect directly to I/O bridge 107. The following description provides example implementations of the computer system 100, among other things.

### Overview of Audio System

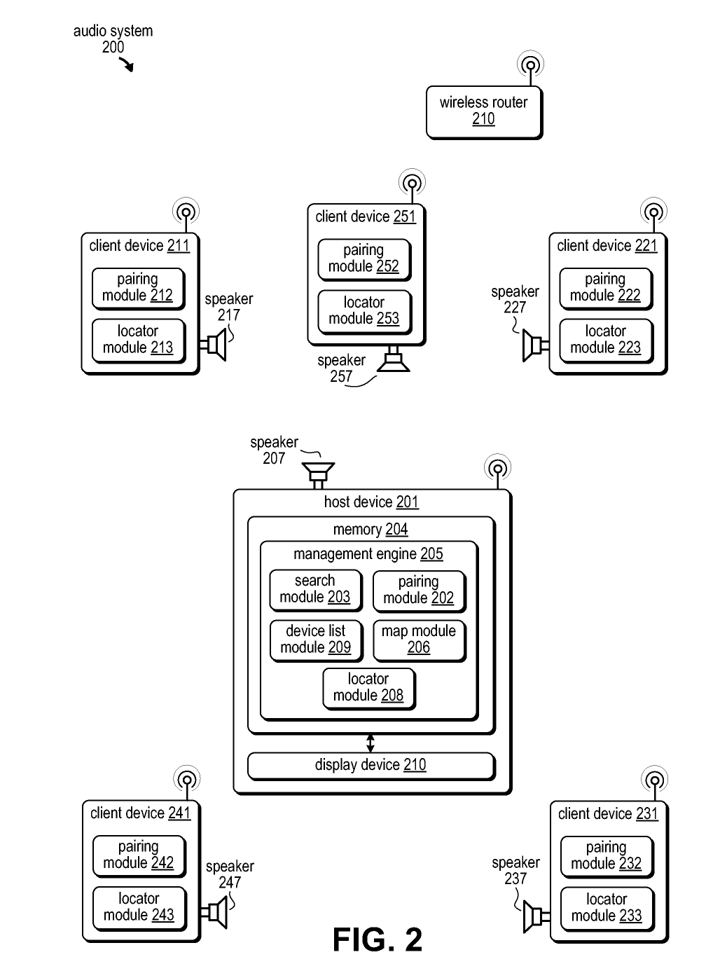

FIG. 2 is a conceptual diagram of an audio system 200 that includes a management engine 205 on a host device 201, according to one embodiment of the present invention. The management engine 205 is configured to implement one or more aspects of the present invention. The computer system 100 of FIG. 1 is one example implementation of the host device 201. The computing device described herein is illustrative; any other technically feasible configurations fall within the scope of the present invention.

As shown in FIG. 2, the host device 201 is communicatively connected to client devices, including client device 211, client device 221, client device 231, client device 241, and client device 251. The computer system 100 of FIG. 1 is also one example implementation of each client device. For explanatory purposes, five client devices are shown in FIG. 2. However, a person skilled in the art will understand that more or fewer devices may be communicatively connected to the host device 201. A wireless router 210 communicatively connects the devices of the audio system 200 over a wireless network, which may include without limitation a Wireless Fidelity (Wi-Fi) network, a wireless local area network (WLAN), wireless personal area network (WPAN), a wireless mesh network, a wireless metropolitan area network, a wireless wide area network, and/or a cellular network, among other types of networks. In another implementation, the wireless router 210 may be located on the host device 201.

The host device 201 is configured to run the management engine 205 that resides in memory 204. One example of the memory 204 is the system memory 104 of FIG. 1. Referring again to FIG. 2, the management engine 205 is configured to receive input from an end-user and from an audio source, such as, for example, a local audio player (not shown) or an audio streaming source connected over a network (e.g., the Internet). The management engine 205 is configured to instruct the host device 201 to display graphical images and/or video to the end-user via the display device 210.

The management engine 205 includes without limitation a search module 203, a device list module 209, a pairing module 202, a map module 206, and a locator module 208. As further described below, these modules are configured to carry out one or more operations of the management engine 205.

Each client device includes without limitation a pairing module and a locator module. For example, client device 211 includes a pairing module 212 and a locator module 213. Client device 221 includes a pairing module 222 and a locator module 223. Client device 231 includes a pairing module 232 and a locator module 233. Client device 241 includes a pairing module 242 and a locator module 243. Client device 251 includes a pairing module 252 and a locator module 253. As further described below, these modules are configured to carry out one or more operations of the respective client device.

Each client device includes, or is connected to, a speaker. For example, client device 211 is connected to a speaker 217. Client device 221 is connected to a speaker 227. Client device 231 is connected to a speaker 237. Client device 241 is connected to a speaker 247. Client device 251 is connected to a speaker 257.

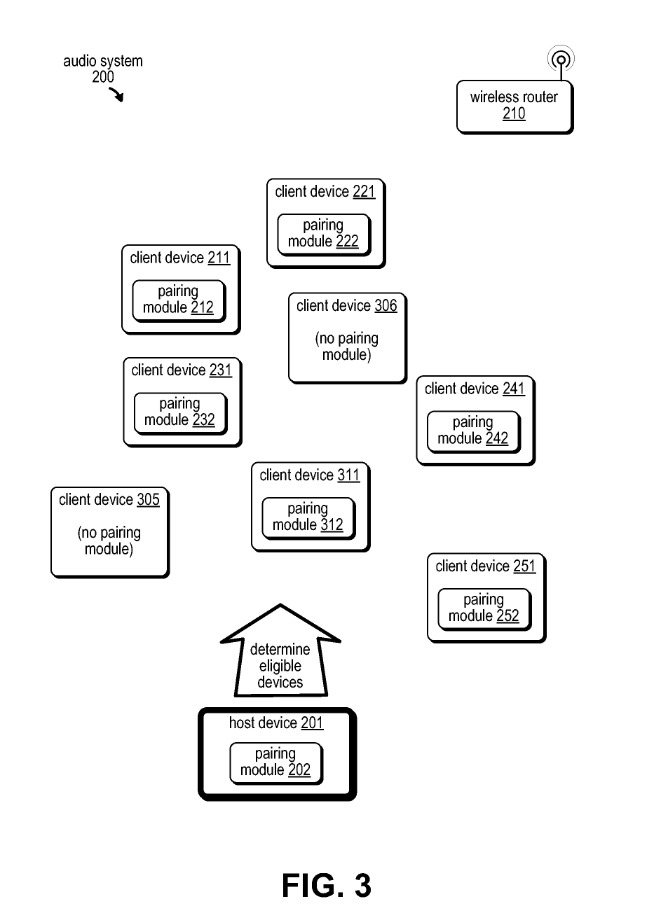

To initiate management of the devices, the search module 203 can determine, or instruct the host device 201 to determine, client devices that are eligible to receive a transmission of the audio data over the wireless network from the host device for playback of the audio data, as further described below with reference to FIG. 3. Determining the eligible client devices may include searching for client devices that are preconfigured with a pairing module (e.g., pairing module 212, pairing module 221, pairing module 231, pairing module 241, pairing module 251) that are configured for connecting each client devices with the pairing module 202 of the host device 201.

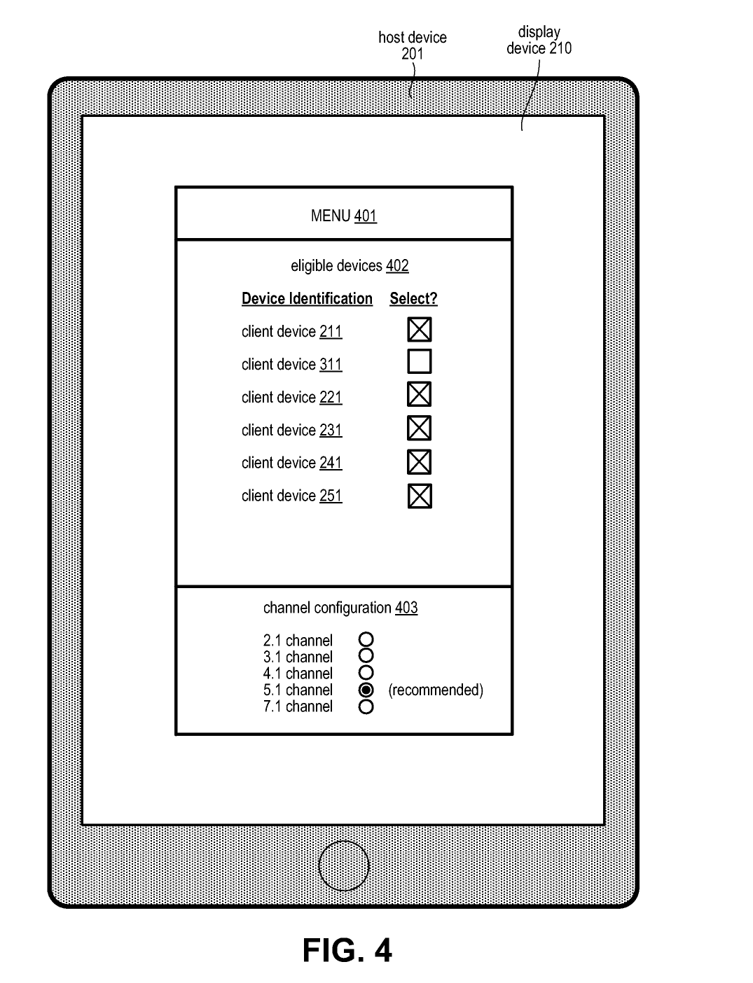

The device list module 209 can display, or instruct the host device 201 to display, the one or more client devices that are eligible, as further described below with reference to FIG. 4. The device module 209 can receive a selection of at least one or the client devices, as further described below with reference to FIG. 4.

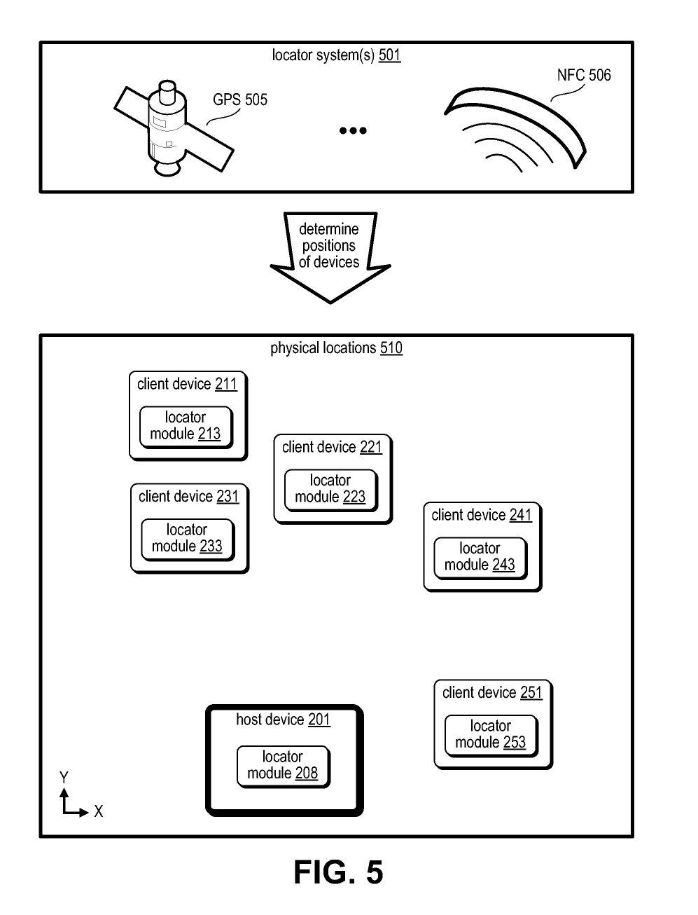

The pairing module 202 can establish, or instruct the host device 201 to establish, a connection to each of the selected client devices for the host device to transmit at least one channel of the audio data to each of the selected client devices over the wireless network, as further described below with reference to FIG. 5.

The map module 206 can display, or instruct the host device 201 to display, on a map a position of the host device relative to each position of each of the selected client devices, as further described below with reference to FIG. 5. For example, each device includes a locator module (e.g., locator module 208, locator module 213, locator module 223, locator module 233, locator module 243, and locator module 253) that is configured for determining the location of the respective devices (e.g., host device 201, client device 211, client device 221, client device 231, client device 241, and client device 251) by using a global position system (GPS) or near field communication (NFC). The host device 201 can communicate with each client device to obtain the position of each device and then display a map of the positions. The host device 201 can receive adjustments of the positions, as necessary. The host device 201 can then perform multichannel playback of the audio data via the connected devices.

### Determining Eligible Client Devices

FIG. 3 is a conceptual diagram of a system for determining the eligible client devices for the audio system 200, according to one embodiment of the present invention. To implement management operations, the host device 201 needs to determine which client devices are eligible for connection.

The host device 301 determines which of the client devices are active on the wireless network and are preconfigured with a pairing module. For example, the host device 201 can communicate with the wireless router 210 to determine which client devices are active on the wireless network. In this example, the host device 201 determines that client device 211, client device 221, client device 231, client device 241, client device 251, client device 305, client device 306, and client device 311 (including pairing device 312) are active on the wireless network.

However, being active does not necessarily mean a client device is eligible for connection. A connection device also needs to include a pairing module.

Accordingly, the host device 301 sends to at least the client device 211 a request for a notification that the client device 211 is preconfigured with a pairing module. A pairing module includes a software application (e.g., applet, plug-in, etc.) that configures a device (e.g., client device) to connect with a pairing module of another device (e.g., host device). A client device can, for example, download a pairing module from a server on the Internet. In the embodiments illustrated herein, the client device 211 is shown preconfigured with the pairing module 212, and so the client device 211 sends, and the host device 201 receives, the notification that the client device 211 is preconfigured with the pairing module. Based on the notification, the host device 201 considers the client device 211 to be eligible for pairing.

The host device 201 can continue these operations, as necessary, to discover other eligible client devices. In this example, the host device also sends a request for notification to all of the other client devices, including client device 221, client device 231, client device 241, client device 251, client device 305, client device 306, and client device 311. In this example, client device 211, client device 221, client device 231, client device 241, client device 251, and client device 311 include pairing modules. Meanwhile, client device 305 and client device 306 do not include pairing modules.

Thus, while performing a search, the host device 201 discovers that client device 211, client device 221, client device 231, client device 241, client device 251, and client device 311 are eligible for pairing because each of these client devices includes a pairing module. As further described below, the host device 201 can then perform operations associated with the client devices that are eligible for connection with the host device 201.

### Selecting Options

FIG. 4 is a conceptual diagram of the host device 201 after the host device 201 discovers which client device are eligible for pairing, according to one embodiment of the present invention. The display device 210 displays a menu 401, including a list of eligible devices 402 and options for choosing a channel configuration 403. From the list of eligible devices 402, the host device 402 can receive one or more selections of eligible devices to connect with the host device 201. In this example, the host device 201 receives a selection of client device 211, client 221, client 231, client 241, and client 251. The client device 311 is unselected.

Also, the display device 210 displays options for selecting a channel configuration 403, including 2.1 channel, 3.1 channel, 4.1 channel, 5.1 channel, or 7.1 channel. Based on the number of selected client devices, the host device 201 shows “5.1 channel” as being the recommended configuration. In this example, the host device 201 receives a selection of a 5.1 channel configuration. In another embodiment, the host device 201 automatically determines the appropriate channel configuration based on the number of selected client devices.

Thus, the host device connects to the selected client devices among the eligible devices 402, in accordance with the selected 5.1 channel configuration. As further described below with reference to FIGS. 5-8, the host device 201 can then perform operations for positioning the client devices.

### Mapping Positions of Devices

In order to send the correct channels to the one or more selected client devices, the host device 201 needs to map the client devices. In order to map the client devices, the host device 201 needs to determine the positions of the selected client devices.

FIG. 5 is a diagram showing the physical locations 510 of the selected client devices of FIG. 4, according to one embodiment of the present invention. The host device 201 can identify the position of the host device and the position of each client device (e.g., client device 211, client device 311, etc.). In this example, the host device 201 and each client device communicates with a locator system 501 to determine positions of each device. The locator system 501 can include, for example, a global position system (GPS) 505 and/or near field communication (NFC) 506.

NFC 302 is a protocol of communication that utilizes electromagnetic radio fields (a.o.t., radio transmissions used by technologies such as Bluetooth and Wi-Fi). NFC 302 is related to radio-frequency identification (RFID) with the exception that NFC 302 is designed for use by devices within close proximity to each other. Devices using NFC may be active or passive. A passive NFC device, such as an NFC tag, contains information that other devices can read, but the passive NFC device does not read any information. A passive NFC device is analogous to a sign on a wall; others can read the information on the sign, but the sign itself does nothing except transmit the info to authorized devices. Active NFC devices can read information and send the information. An active NFC device, like on a smart phone, would not only be able to collect information from NFC tags, but the active NFC device would also be able to exchange information with other compatible phones or devices and could even alter the information on the NFC tag if authorized to make such changes. Each locator module in FIG. 5 may include a passive NFC device or an active NFC device.

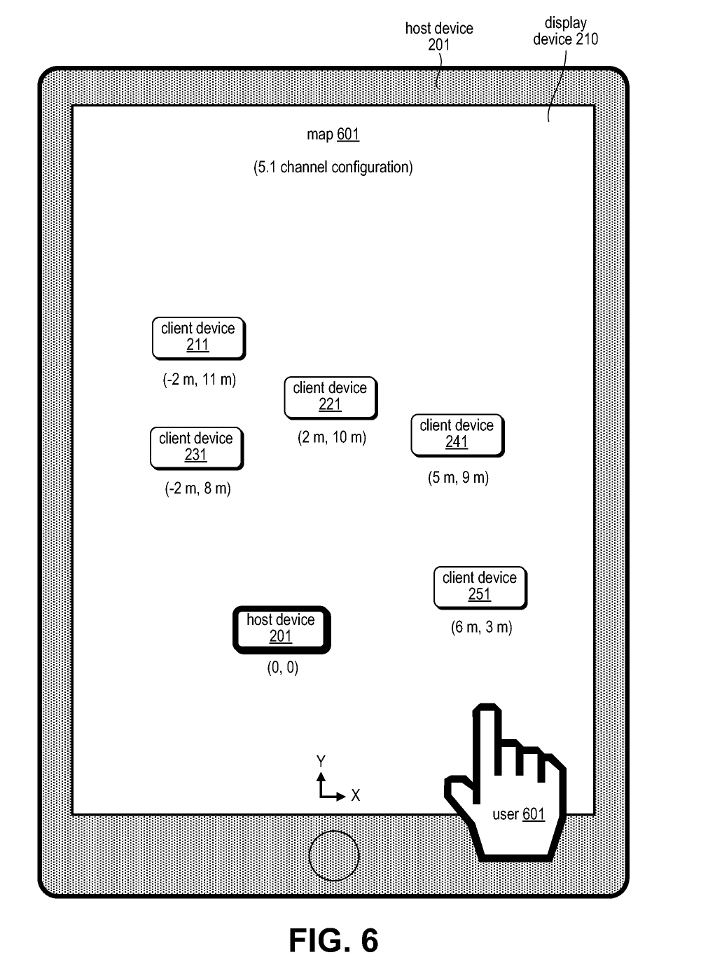

The locator system 501 (e.g., GPS 505 or NFC 506) can determine a location of a device by detecting a locator module of a device (e.g., locator module 213 of client device 211, etc.). Each locator module can include, for example, a GPS receiver to communicate with GPS 505 and/or an NFC device to communicate with another locator module in NFC 506. Each locator module receives and/or calculates the position of the respective device. The host device 201 communicates with a particular client device and receives from the client device the position of the client device. Alternatively, the host device 201 receives from the locator system 501 (e.g., GPS 505) the position of the host device 201 and/or the position of each client device (e.g., client device 211, client device 221, client device 231, client device 241, and client device 251, etc.).

Where the connected devices are indoors and/or have poor communication with the GPS 505, communication with the NFC 506 may be more effective for determining positions of devices. In contrast, where the connected devices are outdoors and/or have poor communication with the NFC 506, communication with the GPS 505 may be more effective for determining positions of devices. As further described below with reference to FIG. 6, the host device 201 can then generate a map based on the positions of the client devices.

FIG. 6 is a conceptual diagram of the host device 201 displaying a map 601 of the selected client devices of FIGS. 4 and 5, according to one embodiment of the present invention. As shown in FIG. 6, the host device 201 displays the positions of the selected client devices, including client device 211, client device 221, client device 231, client device 241, and client device 251 on a map 601. In this example, the host device 201 maps the positions of the selected client devices relative to the position of the host device 201 in an x-y coordinate system. For example, the host device 201 positions the host device 201 in the map 601 at an origin of (0, 0). The host device 201 positions the client device 211 in the map 601 at a location of (−2 m, 11 m). The host device 201 positions the client device 221 in the map 601 at a location of (2 m, 10 m). The host device 201 positions the client device 231 in the map 601 at a location of (−2 m, 8 m). The host device 201 positions the client device 241 in the map 601 at a location of (5 m, 9 m). The host device 201 locates the client device 251 in the map 601 at a location of (6 m, 3 m). In another embodiment, the host device can establish the positions of the client devices relative to another location besides the host device. For example, the host device 201 can receive user input indicating the origin (0, 0) is at any user-defined location on the map 601.

Alternatively, the host device 201 can identify positions of the devices by receiving manual input from a user 601, regardless of where the devices are physically located. This manual option may be desirable, for example, in a situation where neither the GPS 505 nor the NFC 506 of FIG. 5 is operating effectively. For example, as shown in FIG. 6, the host device 201 can identify the position of the host device 201 by receiving, from an input field (e.g., area on a touch screen) of the display device 210 associated with the map 601, a selection that indicates the position of the host device 201. For instance, the host device 201 can receive input from the user 601 selecting an icon associated with a particular client device and then dragging the icon along the display device 210 to the desired location. In one embodiment, such manual placement can override position data received from a locator system 501 of FIG. 5. In one embodiment, the manual placement may include receiving coordinates, for example, receiving x and y coordinates from an input field of the display device 210. Based on the manual placement of the user 601 of FIG. 6, the host device 201 can regard the positioning as being the positions of the client devices for the purpose of sending one or more channels to each client device.

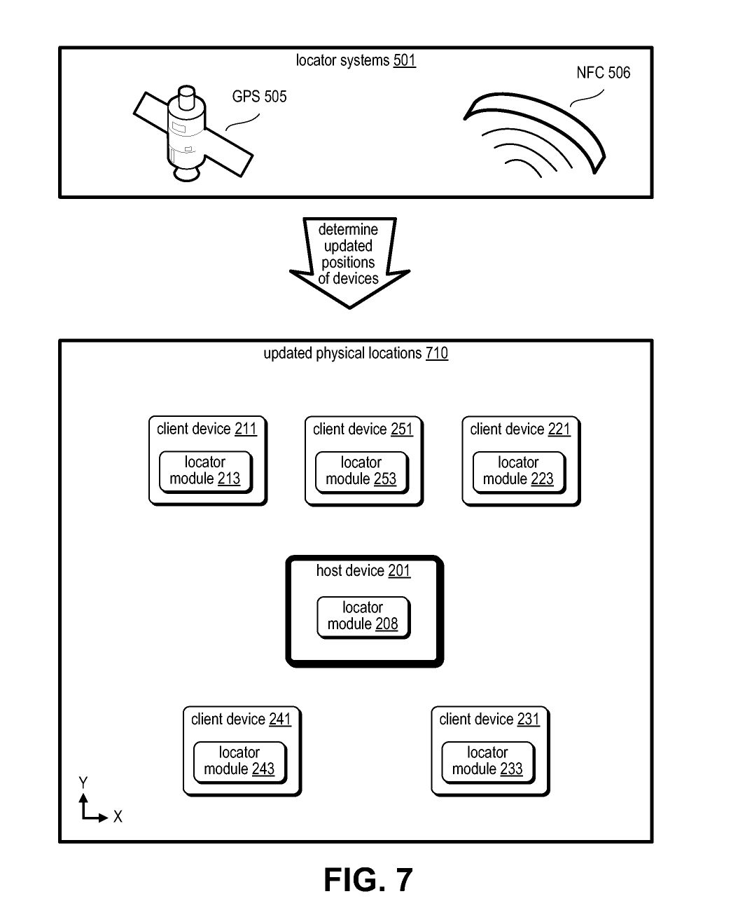

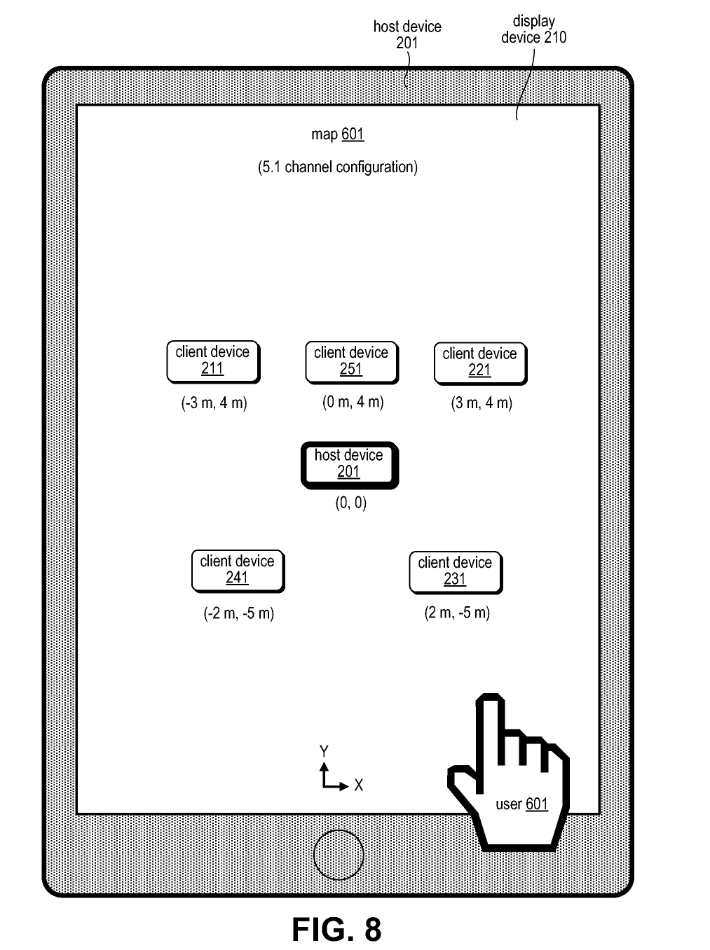

However, the initial positions of the devices may not be positioned optimally for the selected channel configuration. For example, the client devices on the map 601 may not be positioned optimally for the selected 5.1 channel configuration. Accordingly, the host device 201 may receive a request to update positioning as needed, as further described below with reference to FIGS. 7 and 8.

FIG. 7 is a diagram showing updated physical locations 710 of the selected client devices of FIG. 4, according to one embodiment of the present invention. This example is like the example of FIG. 5, except the selected client devices are located in updated positions that are more suitable for a 5.1 channel configuration. For example, the user has physically moved the selected client devices to updated physical locations. A locator system 501 (e.g., GPS 505 or NFC 506) detects the updated positions. Each locator module receives and/or calculates the updated position of the respective device. The host device 201 communicates with a particular client device and receives from the client device the updated position of the client device. Alternatively, the host device 201 receives from the locator system 501 (e.g., GPS 505) the updated position of the host device 201 and/or the position of each client device (e.g., client device 211, client device 221, client device 231, client device 241, and client device 251, etc.). As further described below with reference to FIG. 8, the host device 201 can then update the map 601 based on the updated positions of the client devices.

FIG. 8 is a conceptual diagram of the host device 201 displaying the map 601 of the selected client devices at updated positions, according to one embodiment of the present invention. The host device 201 maps the positions of the selected client devices, including client device 211, client device 221, client device 231, client device 241, and client device 251. In this example, the host device 201 maps the updated positions of the selected client devices relative to the position of the host device 201 in an x-y coordinate system. For example, the host device 201 positions the host device 201 in the map 601 at an origin of (0, 0). The host device 201 positions the client device 211 in the map 601 at a location of (−3 m, 4 m). The host device 201 positions the client device 221 in the map 601 at a location of (3 m, 4 m). The host device 201 positions the client device 231 in the map 601 at a location of (2 m, −5 m). The host device 201 positions the client device 241 in the map 601 at a location of (−2 m, −5 m). The host device 201 positions the client device 251 in the map 601 at a location of (0 m, 4 m).

Alternatively, as described above with reference to FIG. 6, the host device 201 can identify positions of the devices by receiving manual input from a user 601, regardless of where the devices are actually located. Based on the manual placement, the host device 201 can regard the positioning as being the positions of the client devices for the purpose of sending one or more channels to each client device.

### Overview of Method

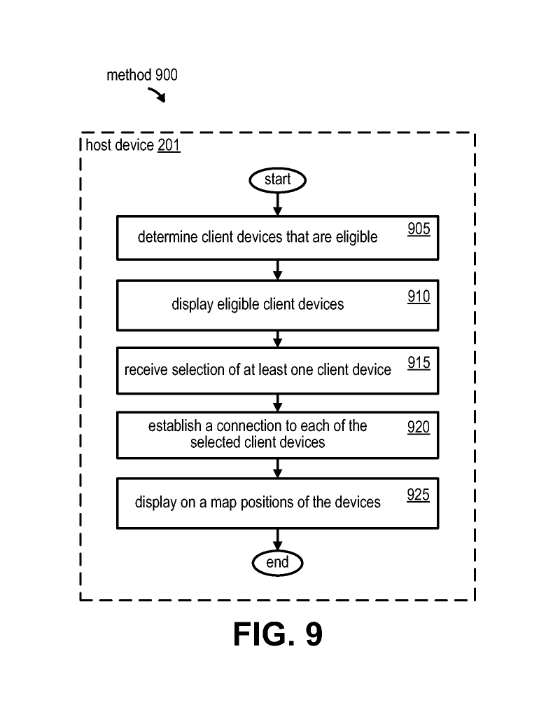

FIG. 9 is a flowchart of method steps for managing multichannel playback of audio data, according to embodiments of the present invention. Although the method steps are described herein in conjunction with the host device 201 of FIG. 2, one skilled in the art will understand that any system configured to implement the method steps, in any order, falls within the scope of the present invention.

As shown in FIG. 9, a method 900 begins in step 905 where the management engine 205 determines one or more client devices that are eligible to be connected to the host device 201. For example, the host device 201 searches over the wireless network for one or more client devices that have an active pairing module. The host device 201 can also contact a client device that is associated with a phone number.

At step 910, the host device 201 displays the eligible client devices. For example, the host device 201 can display each client device that the host device 201 determines to have a pairing module.

At step 915, the host device 201 receives a selection of at least one client device. For example, the host device 201 can display a menu showing the eligible client devices and can receive a selection of at least one client device.

At step 920, the host device 201 establishes a connection with each of the selected client devices. For example, the pairing module of the host device 201 can establish a connection with each pairing module of each selected host device.

At step 925, the host device 201 displays on a map the positions of the connected devices, including the host device and the one or more selected client devices. For example, the host device 201 can receive position data from a GPS, an NFC, or manual input of a user. The host device 201 can then send one or more channels to the appropriate device. Through the connected devices that the host device manages, the audio system can play multichannel audio through the speakers of the connected devices.

This method 900 of FIG. 9 may include other steps and/or details that are not discussed in this method overview. Other steps and/or details described herein may be a part of the method, depending on the implementation. Persons skilled in the art will understand that any system configured to implement the method steps, in any order, falls within the scope of the present invention.

### Example Scenarios for Audio System

The following description provides some example scenarios to provide a practical context of the present approach. However, a person of ordinary skill will understand that the present approach is not limited to these specific scenarios and that a multitude of other scenarios are feasible.

In a first example scenario, suppose a user is watching with friends a movie on a liquid crystal display (LCD), which is part of a host device (e.g., laptop, tablet, or mobile phone, etc.). The user does not have any home theatre (multichannel audio system) with him. Using the present approach, the user can ask his friends to connect the phones of the friends to his home wireless network (e.g., Wi-Fi network) via a wireless router. Depending upon the number of devices the user wants to configure, the host device of the user can form a multichannel audio system. For example, if the user has three devices for connection, the host device can configure a 2.1 multichannel audio system, including one host device and two client devices of the friends.

According to the present approach, of all the connected devices, one device acts as a host device. Each of the other devices acts as a client device. Any device can be the host device as per a selection of the user. The user can physically place the connected devices in a surround pattern as per the audio requirements of the user. The host device displays a user interface for configuring all the connected devices. For example, if the user wants to configure a 5.1 channel configuration, then one device will act as a front-left, a second device will act as back-left, and so on. As shown in FIGS. 6 and 8, the user can configured the devices accordingly on the user interface. Once the host devices establishes the appropriate connections between the client devices and the host device, these connected devices can start playing multichannel audio data that the host device sends to the appropriate devices according to the positioning of the devices. This audio system can emit a sound that the user perceives as a full-fledge multi-channel audio system.

In a second example scenario, the user is travelling or is outdoors. The volume of the inbuilt speaker of the mobile device of the user is too low for effective listening. The user can ask his friends to connect cell phones to his home wireless network (e.g., Wi-Fi network) via a wireless router. Depending upon the number of devices the user wants to configure, the host device of the user can form a multichannel audio system. For example, if audio content is stereo, then the host device can send stereo audio data to each client device so that each client device can play the audio data in stereo. Thus, as the host device plays audio content, the collective volume from the connected devices will be high enough to be heard outdoors.

In a third example scenario, the user is in a large hall and is avoiding connecting speakers via long cables. The user can keep the speakers at corners of the hall and connect each speaker to a smart phone via a 3.5 mm jack on each smart phone. An amplifier can supply power to each speaker independently. The smart phones are connected over a wireless network (e.g., Wi-Fi network) and are configured in a multichannel audio system. The host device starts playing audio. The smart phones receive the audio data and play the audio data through the speakers so that the speakers play amplified audio. Thus, the host device can manage a multichannel audio system without having to connect long, cumbersome cables and/or wires.

Advantageously, the present approach does not require additional hardware to implement the multichannel communication. The host device can send one or more channels to existing inbuilt speakers of the client devices and/or the host device. The audio system is highly scalable according to the needs of the user. For example, the host device can configure the audio system, including the client devices and/or the host device, to play audio data according to a channel configuration of 2.1, 3.1, 4.1, 5.1, or 7.1, and so on. The audio system of the present approach is high portable. For example, wherever a host device is located in a capable wireless network with capable client devices, the host device can form and manage a multichannel audio system. The managed audio system can emit a sound that the user perceives as a full-fledge multi-channel audio system.

One embodiment of the invention may be implemented as a program product for use on a computer system, such as the host device 201 of FIG. 2 for example. One or more programs of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. A method for a host device to manage multichannel playback of audio data, the method comprising:
determining one or more client devices that are eligible to receive a transmission of the audio data over a wireless network from the host device for playback of the audio data;
displaying the one or more client devices that are eligible;
receiving a selection of at least one of the client devices; and
establishing a connection to each of the selected client devices for the host device to transmit at least one channel of the audio data to each of the selected client devices over the wireless network.

2. The method of claim 1, wherein determining one or more client devices are eligible comprises: searching over the wireless network for one or more client devices that are pre-configured with a pairing module for establishing a connection with the host device to receive the transmission of the audio data.

3. The method of claim 2, wherein the searching comprises:
sending to a client device a request for a notification that the client device is pre-configured with the pairing module; and
receiving from the client device the notification that the client device is pre-configured with the pairing module.

4. The method of claim 1, wherein determining one or more client devices are eligible comprises:
receiving a phone number;
contacting a client device that is associated with the phone number;
sending to the client device a request for a notification that the client device is preconfigured with a pairing module for establishing a connection with the host device to receive the transmission of the audio data; and
receiving from the client device a notification that the client device is preconfigured with the pairing module.

5. The method of claim 1, further comprising:
identifying a position of the host device;
determining a position of each of the selected client devices; and
displaying on a map a position of the host device relative to each position of each of the selected client devices.

6. The method of claim 5, wherein:
identifying the position of the host device comprises: receiving from a global position system the position of the host device; and
determining the position of each of the selected client devices comprises:
receiving from each selected client device each position of each of the selected client devices.

7. The method of claim 5, wherein:
identifying the position of the host device comprises: receiving from a near field communication system the position data of the host device, and
determining the position of each of the selected client devices comprises:
receiving from each selected client device each position of each of the selected client devices.

8. The method of claim 5, wherein identifying the position of the host device comprises: receiving from an input field associated with the map a selection that indicates the position of the host device.

9. The method of claim 5, wherein identifying the position of each of the selected client devices comprises: receiving from an input field associated with the map one or more selections that indicate the position of each of the selected client devices.

10. A computer device for managing multichannel playback of audio data, the computer device comprising:
a management engine configured to perform steps of:
determining one or more client devices that are eligible to receive a transmission of the audio data over a wireless network from the host device for playback of the audio data;
displaying the one or more client devices that are eligible;
receiving a selection of at least one of the client devices; and
establishing a connection to each of the selected client devices for the host device to transmit at least one channel of the audio data to each of the selected client devices over the wireless network.

11. The computer device of claim 1, wherein determining the one or more client devices are eligible further configures the management engine to perform steps of: searching over the wireless network for one or more client devices that are pre-configured with a pairing module for establishing a connection with the host device to receive the transmission of the audio data.

12. The computer device of claim 2, wherein the searching further configures the management engine to perform steps of:
sending to a client device a request for a notification that the client device is pre-configured with the pairing module; and
receiving from the client device the notification that the client device is pre-configured with the pairing module.

13. The computer device of claim 1, wherein determining one or more client devices are eligible further configures the management engine to perform steps of:
receiving a phone number;
contacting a client device that is associated with the phone number;
sending to the client device a request for a notification that the client device is preconfigured with a pairing module for establishing a connection with the host device to receive the transmission of the audio data; and
receiving from the client device a notification that the client device is preconfigured with the pairing module.

14. The computer device of claim 1, wherein the management engine is further configured to perform steps of:
identifying a position of the host device;
determining a position of each of the selected client devices; and
displaying on a map a position of the host device relative to each position of each of the selected client devices.

15. The computer device of claim 5, wherein the management engine is further configured to perform steps of:
identifying the position of the host device comprises: receiving from a global position system the position of the host device; and
determining the position of each of the selected client devices comprises:
receiving from each selected client device each position of each of the selected client devices.

16. The computer device of claim 5, wherein:
identifying the position of the host device further configures the management engine to perform a step of: receiving from a near field communication system the position data of the host device, and
determining the position of each of the selected client devices further configures the management engine to perform a step of: receiving from each selected client device each position of each of the selected client devices.

17. The computer device of claim 5, wherein identifying the position of the host device further configures the management engine to perform a step of: receiving from an input field associated with the map a selection that indicates the position of the host device.

18. The computer device of claim 5, wherein identifying the position of each of the selected client devices further configures the management engine to perform a step of: receiving from an input field associated with the map one or more selections that indicate the position of each of the selected client devices.

19. One or more computer-readable storage media comprising one or more instructions to manage multichannel playback of audio data, wherein the one or more instructions, when executed, direct one or more processors to perform steps comprising:
determining one or more client devices that are eligible to receive a transmission of the audio data over a wireless network from the host device for playback of the audio data;
displaying the one or more client devices that are eligible;
receiving a selection of at least one of the client devices; and
establishing a connection to each of the selected client devices for the host device to transmit at least one channel of the audio data to each of the selected client devices over the wireless network.

20. The method of claim 1, wherein further comprising steps of:
identifying a position of the host device;
determining a position of each of the selected client devices; and
displaying on a map a position of the host device relative to each position of each of the selected client devices.
